(19) United States
(12) Patent Application Publication
(10) Pub. No.: US 2007/0078971 A1
(43) Pub. Date: Apr. 5, 2007

(54) Methods, systems and computer program products for providing activity data

(76) Inventors: Samuel Zellner, Dunwoody, GA (US); John Ruckart, Atlanta, GA (US)

Correspondence Address: MYERS BIGEL SIBLEY & SAJOVEC, P.A., P.O. BOX 37428, RALEIGH, NC, 27627, US

(21) Appl. No.: 11/313,574

(22) Filed: Dec. 21, 2005

Related U.S. Application Data
(60) Provisional application No. 60/717,156, filed on Sep. 15, 2005.

(51) Int. Cl. G06F 15/173

(52) U.S. Cl. 709/224

(57) ABSTRACT

Methods, systems and computer program products for providing activity data are provided. Activity data associated with an activity of one or more subscribers of a presence service is received at a presence server. The activity data is provided, from the presence server, to one or more other subscribers of the presence service.

### CROSS REFERENCE TO RELATED APPLICATION

This Application is related to and claims the priority from U.S. Provisional Patent Application Ser. No. 60/717,156, filed Sep. 15, 2005, entitled Systems and Methods for Sharing Activity Information, the disclosure of which is hereby incorporated herein by reference.

### FIELD OF THE INVENTION

The present invention generally relates to the field of communications services and, more particularly, to methods, systems and computer program products for communicating data between devices.

### BACKGROUND OF THE INVENTION

It is becoming more commonplace for people to own more than one communications device that allows communication between users. For example, people communicate using home phones, work phones, mobile phones and the like. Furthermore, people also communicate using devices, such as personal computers (PCs), personal digital assistants (PDAs), pagers and the like, using, for example, email and instant messaging functionalities of these devices.

These devices can be used to, for example, access the Internet. Recently, Internet-based instant messaging applications have become popular for use in communication with selected other users without the delays associated with conventional electronic mail. In a typical instant messaging application, for example, AOL Instant Messenger, a user prepares a message for delivery to one or more other users, typically on a so-called “buddy list,” and transmits the message for delivery. The user receives messages from members of the buddy list in a similar manner. Users are generally identified by one or more “screen names.”

Instant messaging is generally based on the availability of a potential message recipient. Unlike email in which message delivery and response delays are customary, instant messaging is based on immediate response, and it is generally undesirable to send instant messages to a user who receives the messages hours or days later. Thus, applications capable of indicating status or presence of a user online have been developed, for example, applications, such as Instant Messaging and Presence (IM&P) services.

Users are typically connected to the Internet using computers, personal digital assistants (PDAs), web enabled mobile terminals or similar devices, and are allocated either a fixed internet protocol (IP) address or a dynamic IP address, i.e., an IP address assigned by the internet service provider (ISP). A first user of the IM&P services may register his presence with a presence server using the Internet by sending his username (screen name) and IP address to the presence server, thereby making his presence information available to other users, for example, subscribers. The first user may also be a subscriber and subscribe to the presence of second and third users. Thus, the presence server may inform the first user of the status or presence of the second and third users. For example, the second user may register his presence with the presence server, making his presence information available to all other users who are subscribed to the second user's presence. When the second user logs on, all of the users subscribed to the second user's presence, including the first user, may receive a notification that the second user has logged on. The presence of the first, second and third users may be depicted on a display at the devices being used by the first, second and third users. For example, a “buddy list” may include a combination of screen names and icons, the presence of which on the display may indicate a user's presence online. Furthermore, the “buddy list” may also include an indication of the user's availability, for example, available, unavailable, busy, and the like.

Many standards for instant messaging and presence applications have recently been developed responsive to the increased use of such services. For example, the Wireless Village Standard and the Instant Messaging and Presence Standard (IMPS) have been developed to extend instant messaging and presence capabilities to portable electronic devices.

### SUMMARY OF THE INVENTION

Some embodiments of the present invention provide methods, systems and computer program products for providing activity data. Activity data associated with an activity of one or more subscribers of a presence service is received at a presence server. The activity data is provided, from the presence server, to one or more other subscribers of the presence service.

In further embodiments of the present invention, an activity indicator associated with the activity of the one or more subscribers may be altered on a display of a client device associated with the at least one other subscriber. The activity indicator may illustrate a current activity, a past activity and/or a future activity of the one or more subscribers. In certain embodiments of the present invention, the activity indicator may further illustrate a mood of the one or more subscribers. The mood may indicate the at least one subscriber's satisfaction with the current activity, the past activity and/or the future activity.

In still further embodiments of the present invention, an activity of the one or more other subscribers of the presence service may be modified based on the activity data associated with the one or more subscribers. In certain embodiments of the present invention, the activity of the one or more other subscribers of the presence service may be automatically modified to be the same as the activity of the at least one subscriber.

In some embodiments of the present invention, the one or more subscribers may be a group of subscribers. The activity of the one or more other subscribers may be modified based on a most popular activity among the group of subscribers.

In further embodiments of the present invention, an invitation to join a current activity and/or a future activity of the one or more subscribers may be received. The activity data may be associated with a TV channel, a radio station, a universal resource locator (URL), a phone call and/or a conference call.

### BRIEF DESCRIPTION OF THE FIGURES

Other features of the present invention will be more readily understood from the following detailed description of exemplary embodiments thereof when read in conjunction with the accompanying drawings, in which:

FIG. 1 is a block diagram of a data processing system suitable for use in devices according to some embodiments of the present invention.

FIG. 2 is a block diagram of a system including devices according to some embodiments of the present invention.

FIG. 3 is an exemplary “Activity Menu” including activity indicators according to some embodiments of the present invention.

FIGS. 4 through 7 are flowcharts illustrating operation according to various embodiments of the present invention.

### DETAILED DESCRIPTION OF EMBODIMENTS OF THE INVENTION

The present invention now will be described more fully hereinafter with reference to the accompanying figures, in which embodiments of the invention are shown. This invention may, however, be embodied in many alternate forms and should not be construed as limited to the embodiments set forth herein. Like numbers refer to like elements throughout the description of the figures.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein the term “and/or” includes any and all combinations of one or more of the associated listed items.

It will be understood that, when an element is referred to as being “coupled” to another element, it can be directly coupled to the other element or intervening elements may be present. In contrast, when an element is referred to as being “directly coupled” to another element, there are no intervening elements present.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

The present invention may be embodied as methods, systems, and/or computer program products. Accordingly, the present invention may be embodied in hardware and/or in software (including firmware, resident software, micro-code, etc.). Furthermore, the present invention may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific examples (a nonexhaustive list) of the computer-readable medium would include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

The present invention is described below with reference to block diagrams and/or flowchart illustrations of methods, apparatus, and computer program products according to embodiments of the invention. It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved.

It will be understood that at least a portion of the communications described herein can be provided according to Session Initiation Protocol (SIP), which is described in more detail in, for example, “Internet Communications Using SIP,” by Henry Sinnreich, ISBN: 0-471-41399-2. Internet Protocol communications are generally described in, for example, “TCP/IP Protocol Suite,” by Behrouz A Forouzan, ISBN: 0-07-119962-4. Moreover, techniques for the creation and operation of virtual communities, is described in, for example, “Design for Community: The Art of Connecting Real People in Virtual Places,” by Derek M. Powazek, ISBN: 0-7357-1075-9. The content of these references is incorporated herein by reference.

The communications between the presence server and user devices discussed herein may be provided using an Internet Protocol (IP) Multimedia Subsystem (IMS). IMS can utilize a packet switched domain (such as the Internet) to transport multimedia signaling and bearer traffic. For example, a Universal Mobile Telecommunication System (UMTS) may be used to access multimedia services of IMS. IP Multimedia Systems are discussed in each of the following: (1) 3GPP TS 22.228 entitled “Service Requirements for the IP Multimedia Core Network Subsystems”; (2) 3GPP TS 23.228 entitled “IP Multimedia Subsystems”; and (3) 3GPP TR 22.941 entitled “IP Based Multimedia Services Framework.” The subject matter of each of these references is hereby incorporated by reference.

It will be understood that communications between devices, for example, a presence server and/or user devices, can be provided via a TCP/IP Session Initiation Protocol (SIP) message, a SS7 (Signaling System 7) message, a common channel signaling message, an in-band signaling message, and/or a Short Message Service (SMS) message, an Enhanced Message Service (EMS) message, a Multimedia Message Service (MMS) message, and/or Smartmessaging™ message. As is known to those skilled in the art, SMS and EMS messages can be transmitted on digital networks, such as GSM networks, allowing relatively small text messages (for example, 160 characters in size) to be sent and received via a network operator's message center to the user device, or via the Internet, using a so-called SMS (or EMS) “gateways.”

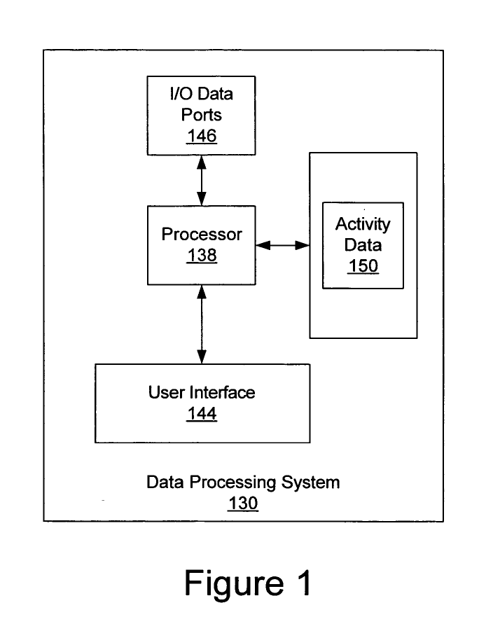

Some embodiments of the present invention will now be discussed with respect FIGS. 1 through 7. As communications become more pervasive people are looking for new ways to communicate with one another. Internet protocol television (IPTV), instant messaging (IM), voice over Internet protocol (VoIP), and the world wide web all offer capabilities for individuals, but do not provide much for group or remote participation. For example, some people prefer watching television, for example, a TV show or movie, in the comfort of their own homes. However, these same people may want to share their television experience with other people, for example, friends or co-workers.

Thus, according to some embodiments of the present invention, activity data associated with one or more subscribers of a presence service may be received at, for example, a presence server. The activity data may be associated with, for example, a TV show, a radio station, a universal resource locator (URL), a phone call, a conference call and/or any other activity in which others may want to share, for example, online games. The activity data associated with the one or more subscribers may be provided to one or more other subscribers of the presence service so as to allow the one or more other subscribers to know and/or share in the activities as will be discussed further herein.

It will be understood that although embodiments of the present invention are discussed herein with respect to a presence server, embodiments of the present invention are not limited to this configuration. For example, the activity data associated with one or more users may be provided directly from a device associated with one or more users to a device associated with the one or more other users without departing from the scope of the present invention.

According to some embodiments of the present invention, a subscriber of a presence service may be able to identify what activity their friends, family, coworkers and the like are currently engaged in, have been engaged in or will be engaged in. For example, according to some embodiments of the present invention a subscriber may determine that his friend John, also a subscriber, is watching a movie entitled “Sweet Home Alabama.” The subscriber may have the same movie tastes as John and, therefore, may decide to watch the same movie. In certain embodiments of the present invention, the movie being watched by John may automatically play on the subscriber's TV as will be discussed further below. Thus, according to some embodiments of the present invention, subscribers may share experiences without being in the same location or even planning to do so in advance.

Referring now to FIG. 1, an exemplary embodiment of a data processing system 130 that may be included in devices, for example, a presence server, user device, such as a television, radio, personal digital assistant (PDA), personal computer (PC), a telephone system and the like, in accordance with some embodiments of the present invention will be discussed. The data processing system 130, may include a user interface 144, including, for example, input device(s) such as a keyboard or keypad, a display, a speaker and/or microphone, and a memory 136 that communicates with a processor 138. The data processing system 130 may further include an I/O data port(s) 146 that also communicates with the processor 138. The I/O data ports 146 can be used to transfer information between the data processing system 130 and another computer system or a network that may be associated with a communications service provider or user communication devices using, for example, an Internet Protocol (IP) connection. These components may be conventional components, such as those used in many conventional data processing systems, which may be configured to operate as described herein. As shown in the embodiments of FIG. 1, the memory 136 includes activity data 150. The elements shown in the memory 136 are provided for exemplary purposes only and, therefore, embodiments of the present invention are not limited to the elements illustrated therein.

It will be understood that as used herein “activity data” refers to information about a current, past or future activity associated with one or more subscribers of a presence service according to some embodiments of the present invention. Activity data may be associated with, for example, a television station, a radio station, a universal resource locator (URL), a telephone call, a conference call, internet protocol television (IPTV), DVR/PVR, video games, online games, shopping, blog, and/or vlog and the like. For example, activity data according to some embodiments of the present invention may be a movie that a subscriber is watching at the present time. It will be further understood that although embodiments of the present invention are discussed herein with respect to television activities, for example, movies, television shows, sporting events and the like, embodiments of the present invention are not limited to these examples. For example, embodiments of the present invention may be used to share information related to a radio station being listened to by a subscriber or a URL being accessed by a subscriber without departing from the scope of the present invention. It will be understood that activities according to some embodiments of the present invention may include events, for example, video events, image events, audio events, interactive events, sensory events and the like without departing from the scope of the present invention.

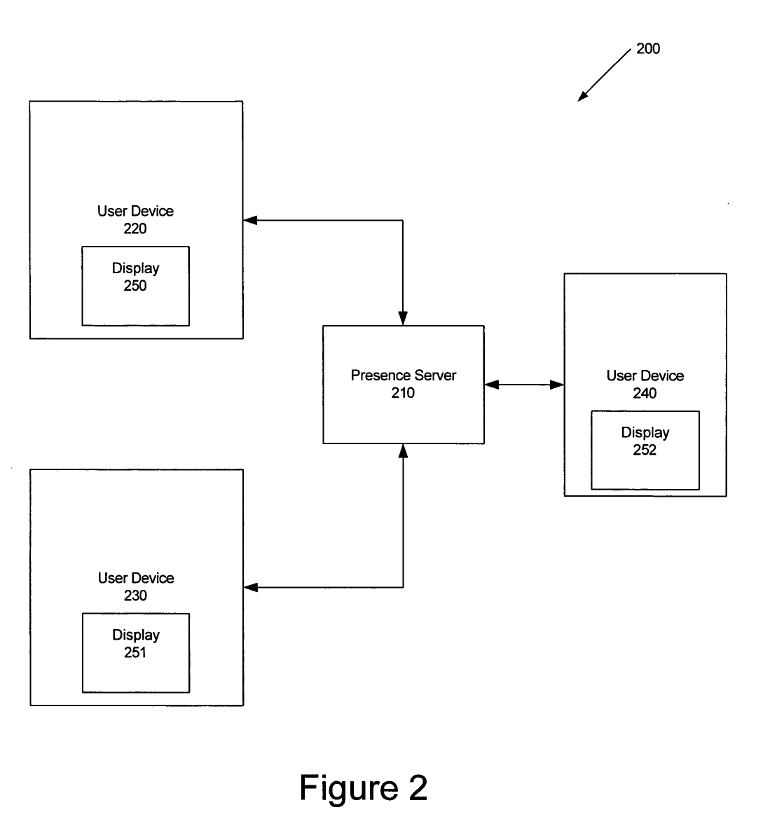

Referring now to FIG. 2, a system 200 including user devices and a presence server according to some embodiments of the present invention will be discussed. The system 200 includes first, second and third user devices 220, 230 and 240 coupled to a presence server 210. The data processing system 130 of FIG. 1 may be included in the first user device 220, the second user device 230, the third user device 240 and/or the presence server 210. Although the first, second and third user devices 220, 230 and 240 are illustrated as communicating through the presence server 210, embodiments of the present invention are not limited to this configuration. For example, the first, second and third user devices may communicate directly without departing from the scope of the present invention.

Furthermore, it will be understood that although the presence server 210 is illustrated as being coupled to three user devices, embodiments of the present invention are not limited to this configuration. For example, the presence server 210 may be coupled to more or less than three user devices without departing from the scope of the present invention.

The first, second and third user devices 220, 230 and 240 may be, for example, a television set and/or set top box, a radio, MP3 player, a personal computer (PC), a PDA, a telephone system (wired or wireless) and the like. As illustrated in FIG. 2, each of the user devices 220, 230 and 240 in the system 200 may include a display 250, 251 and 252. The display may be, for example, a television, a computer screen, and/or a liquid crystal display (LCD) of mobile phone, PDA, MP3 player and the like.

According to some embodiments of the present invention, users may subscribe to a presence service. Presence services are known to those having skill in the art and, therefore, details with respect to these services will not be discussed in detail herein. However, presence services according to some embodiments of the present invention may include security measures. For example, subscribers may provide a user name and password or other means of identification before activity data associated with other subscribers is revealed. Furthermore access may be further limited by requiring a fee for subscribing to the presence service. Presence services according to some embodiments of the present invention may allow a user to customize how the system is configured, for example, how a menu is displayed to the user. Some menus may include, for example, banner ads, sponsorship information associated with activities. However, a user could chose to exclude such information from the menu/display. Furthermore, subscribers of presence services according to some embodiments of the present invention may have the ability to query the activities for descriptive information such as provider, price, sponsor, rating, average recommendation, format, duration, reviews and/or any information relevant to the decision participate in the activity.

Subscribers of the presence service may have access to activity data associated with other subscribers of the presence service. Thus, as discussed herein, subscribers may modify their activities based on activity data associated with other subscribers made available through the presence server 210. For example, a first subscriber associated with a first user device 220 may like the same types of movies as a second subscriber associated with a second user device 230. The first subscriber may configure the first device 220, for example, a television, to display on the screen 250 the same television programs, movies and/or sporting events being viewed by the second subscriber on the second user device 220, for example, a second television.

In some embodiments of the present invention, the activity data associated with the first subscriber of a presence service may be provided to a presence server 210. The presence server 210 may be configured to provide the received activity data to the second subscriber of the presence service. It will be understood that in some embodiments of the present invention the subscribers may exchange presence data without the use of a presence server 210.

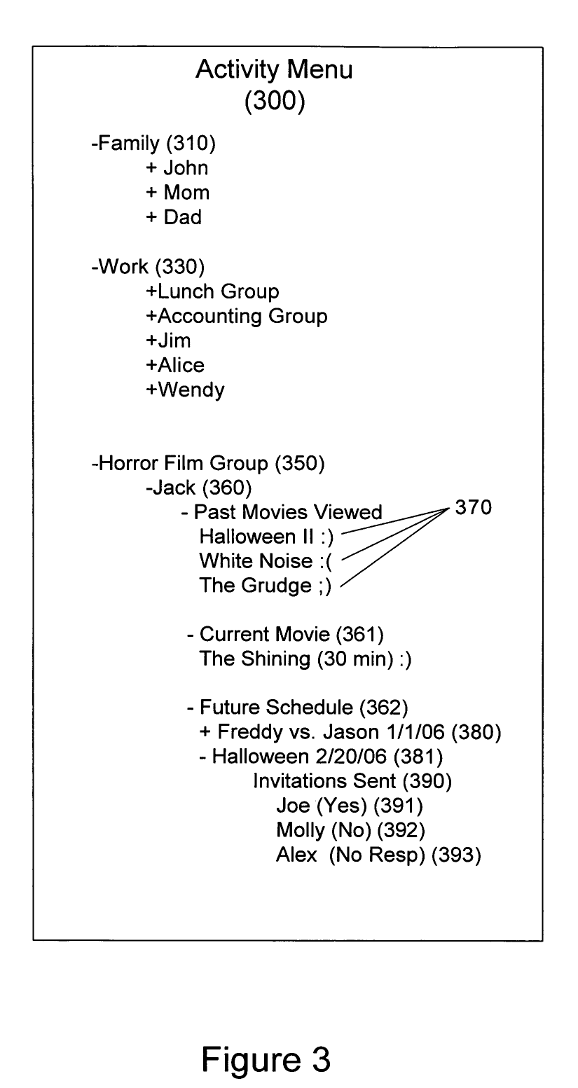

In some embodiments of the present invention, the activity data is provided to the second subscriber by altering an activity indicator associated with the activity of the first subscriber on a display 251 of the second user device 230 associated with the second subscriber. For example, an activity indicator may be included on an Activity Menu associated with the presence service. Activity Menus according to some embodiments of the present invention may be similar to “buddy lists” and will be discussed further below with respect to FIG. 3. The activity indicator may indicate that the first subscriber is watching a movie or listening to a specific radio station. In certain embodiments of the present invention, the activity indicator may be associated with a current activity, a past activity and/or a future activity of the first subscriber. The activity indicator may further illustrate a mood of the first subscriber while, for example, the first subscriber watches the television. The mood may indicate the first subscriber's satisfaction with the current activity, the past activity and/or the future activity. In other words, if the first subscriber is watching a sporting event, the mood may indicate if the subscriber is enjoying the event. For example, if his mood is happy, this may indicate that his team is winning and/or playing well. Mood may also indicate an emotional state, interest level, overall rating, a user recommendation and the like without departing from the scope of the present invention.

The activity of the second subscriber may be modified based on the activity data associated with the first subscriber. For example, the activity of the second subscriber may be automatically modified to be the same as the activity of the first subscriber.

It will be understood that the presence server 210 may receive activity data from more than one subscriber. The second subscriber may view the activity indicators of a group of subscribers and modify his/her activity based on the activity data associated with the group. For example, the activity of the second subscriber may be modified based on a most popular activity among the group of subscribers. For example, a top ten list of movies may be provided based the movies watched by the group of subscribers and their ratings thereof. In some embodiments of the present invention, the moods associated with the movies may be used to rank the movies.

In some embodiments of the present invention, the first subscriber or group of subscribers may send an invitation to the second subscriber to join a current activity and/or a future activity of the first subscriber or group of subscribers. If the second subscriber decides to accept the invitation, the activity of the second subscriber user may be modified based on the activity of the first user or group of subscribers.

As discussed above, activity data may be provided to subscribers using an activity indicator. Activity indicators according to some embodiments of the present invention may be provided on Activity Menus, for example, the Activity Menu 300 of FIG. 3. Referring now to FIG. 3, the Activity Menu 300 may be accessed by methods known to those having skill in the art. For example, the Activity Menu 300 may be a pull down menu on a graphical user interface, may be accessed by pressing a button on remote control for a television or a radio, may be provided as a child window on a web page that can be minimized/maximized by a user and the like.

As illustrated in FIG. 3, the Activity Menu 300 may include a list of subscribers of the presence service that the first subscriber is interested in. These subscribers may be organized in categories, for example, Family 310, Work 330, Groups of interest, for example, a horror film group 350. The Activity Menu 300 may be customized by the subscriber and may include only those other subscribers in which the subscriber is interested.

As further illustrated in FIG. 3, each of the categories may also include subcategories, for example, Work 330 may include a list of individuals (Jim, Alice, Wendy) as well as subcategories (lunch group, accounting group). Thus, for example, if a subscriber is running late for work, the subscriber can check the Activity Menu 300 to determine if he/she is missing, for example, a meeting or a teleconference. If an activity listed under the subcategory Accounting Group indicates an ongoing teleconference, the subscriber may chose to join the teleconference. It will be understood that these categories are provided for exemplary purposes only and, therefore, embodiments of the present invention are not limited to the categories discussed herein.

The subscriber may also include interest groups on the Activity Menu 300, for example, the horror film group 350 which may be composed of subscribers that like horror movies. As illustrated, a subscriber, Jack, is a member of the Horror Film Group 350 and has past, current and future activities associated therewith. For example, the Activity Menu 300 illustrates Past Movies Viewed 360 by Jack, Current Movies 361 being viewed by Jack and Future Schedules 362 of movies to be viewed by Jack. As further illustrated, the past movies include Halloween II, White Noise and The Grudge, each of which has an associated mood 370. The mood 370 may indicate Jack's satisfaction with the movie(s). The current movie being watched by Jack is the Shining. The shining has been running for 30 minutes 372 as indicated on the Activity Menu 300 and Jack seems to be enjoying the movie as indicated by the mood 371. Finally, Jack has schedules two future movie viewings, Freddy vs. Jason 380 on Jan. 1, 2006 and Halloween 281 on Feb. 20, 2006. Jack has also sent invitations 390 to other subscribers, Joe, Molly and Alex, to view Halloween with him on Feb. 20, 2006. As indicated on the Activity Menu 300, Joe has accepted the invitation 391, Molly has declined the invitation 392 and Alex has not responded 393 to the invitation.

Although the Activity Menu 300 is illustrated as having the subscribers/groups represented using words, embodiments of the present invention are not limited to this configuration. For example, subscribers may be represented on Activity menus 300 with icons, symbols, words and the like without departing from the present invention. Furthermore, subscribers of the presence service may choose to be identified on the Activity Menu 300 by a word, name, phrase, icon, username and the like.

It will be further understood that although embodiments of the present invention are discussed herein with respect to subscribers of a presence service, embodiments of the present invention are not limited to this configuration. For example, non-subscribers may obtain activity data by requesting the activity data from the presence server and/or a user device. However, it will be understood that the subscriber associated with the requested activity data may be prompted for permission to provide the activity data to the requestor (non-subscriber) before the information can be provided.

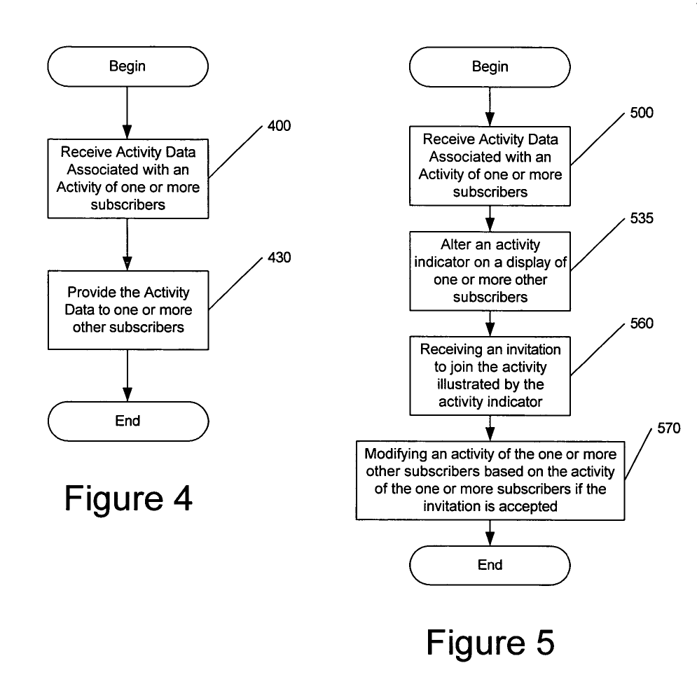

Operations according to some embodiments of the present invention will now be discussed with respect to the flowcharts of FIG. 4 through 7. Referring first to the flowchart of FIG. 4, operations begin at block 400 by receiving, at a presence server, activity data associated with an activity of one or more subscribers of a presence service. The activity data may be associated with, for example, a TV channel, a radio station, a URL, a phone call and/or a conference call. The activity data may be provided, from the presence server, to one or more other subscribers of the presence service (block 430).

Referring now to the flowchart of FIG. 5, operations begin at block 500 by receiving, at a presence server, activity data associated with an activity of one or more subscribers of a presence service. An activity indicator associated with the activity of the one or more subscribers may be altered on a display of a client device associated with the one or more one other subscribers (block 535). The activity indicator may be associated with a current activity, a past activity and/or a future activity of the one or more subscribers. The activity indicator may further indicate a mood of the one or more subscribers. The mood may indicate the one or more subscribers' satisfaction with the current activity, the past activity and/or the future activity.

An invitation to join the activity associated with the one or more subscribers may be received by the one or more other subscribers (block 560). If the invitation is accepted, an activity of the one or more other subscribers of the presence service may be modified based on the activity data associated with the one or more subscribers (block 570). In some embodiments of the present invention, the activity of the one or more other subscribers may be automatically modified to be the same as the current and/or future activity associated with the one or more subscribers.

It will be understood that the one or more subscribers may be a group of subscribers and the activity of the one or more other subscribers may be modified based on a most popular activity among the group of subscribers. For example, the most popular movie viewed by the group of subscribers.

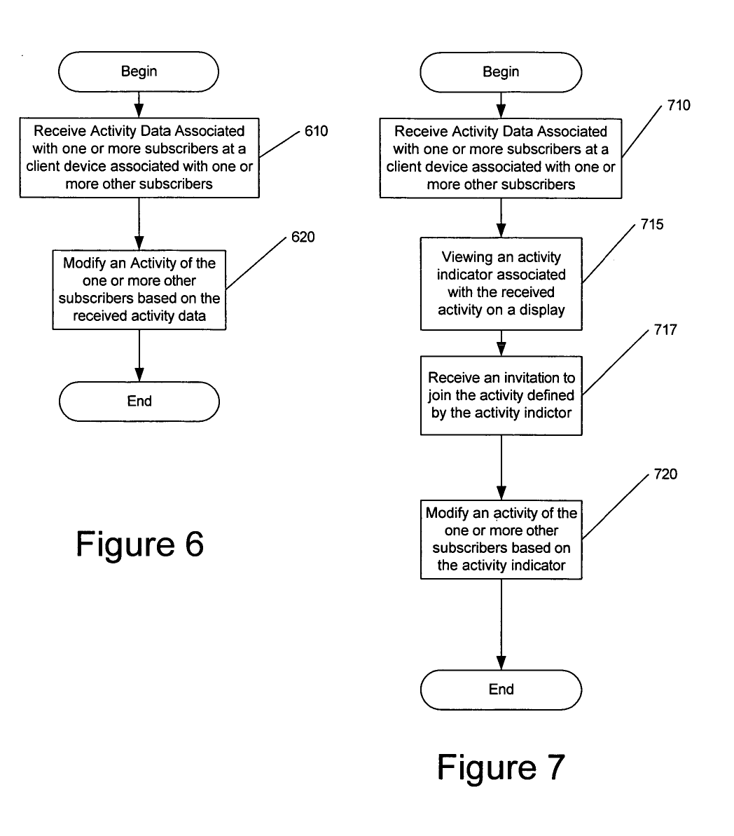

Referring now to the flowchart of FIG. 6, operations begin at block 610 by receiving activity data associated with an activity of one or more subscribers of a presence service at a client device associated with one or more other subscribers of the presence service. An activity of the one or more other subscribers may be modified based on the received activity data (block 620).

Referring now to the flowchart of FIG. 7, operations begin at block 710 by receiving activity data associated with an activity of one or more subscribers of a presence service at a client device associated with one or more other subscribers of the presence service. The activity of the one or more subscribers may be, for example, a current activity, a past activity and/or a future activity. An activity indicator associated with the activity of the one or more subscribers may be viewed on a display of the client device associated with the one or more other subscribers (block 715). The activity indicator may further include a mood of the one or more subscribers. The mood may indicate the one or more subscribers' satisfaction with the current activity, the past activity and/or the future activity. An invitation to join the activity associated with the one or more subscribers may be received by the one or more other subscribers (block 717). If the invitation is accepted, an activity of the one or more other subscribers of the presence service may be modified based on the activity data associated with the one or more subscribers (block 720).

In the drawings and specification, there have been disclosed embodiments of the invention and, although specific terms are employed, they are used in a generic and descriptive sense only and not for purposes of limitation, the scope of the invention being set forth in the following claims.

That which is claimed is:

1. A method of providing activity data comprising:
receiving, at a presence server, activity data associated with an activity of at least one subscriber of a presence service; and
providing the activity data, from the presence server, to at least one other subscriber of the presence service.

2. The method of claim 1, wherein providing comprises altering an activity indicator associated with the activity of the at least one subscriber on a display of a client device associated with the at least one other subscriber.

3. The method of claim 2, wherein the activity indicator illustrates a current activity, a past activity and/or a future activity of the at least one subscriber.

4. The method of claim 3, wherein the activity indicator further illustrates a mood of the at least one subscriber, the mood indicating the at least one subscriber's satisfaction with the current activity, the past activity and/or the future activity.

5. The method of claim 1, further comprising modifying an activity of the at least one other subscriber of the presence service based on the activity data associated with the at least one subscriber.

6. The method of claim 5, wherein modifying comprises automatically modifying the activity of the at least one other subscriber of the presence service to be the same as the activity of the at least one subscriber.

7. The method of claim 5, wherein the at least one subscriber comprises a group of subscribers and wherein modifying comprises modifying the activity of the at least one other subscriber based on a most popular activity among the group of subscribers.

8. The method of claim 5, wherein modifying is preceded by receiving an invitation to join a current activity and/or a future activity of the at least one subscriber.

9. The method of claim 1, wherein the activity data is associated with a TV channel, a radio station, a universal resource locator (URL), a phone call and/or a conference call.

10. A computer program product for managing user information across multiple devices associated with the user, the computer program product comprising computer program code embodied in a computer readable medium, the computer program code comprising program code configured to carry out the method of claim 1.

11. A computer system configured to carry out the method of claim 1.

12. A method of providing activity data, comprising:
receiving activity data associated with an activity of at least one subscriber of a presence service at a client device associated with at least one other subscriber of the presence service; and
modifying an activity of the at least one other subscriber based on the received activity data.

13. The method of claim 12, wherein modifying is preceded by viewing an activity indicator associated with the activity of the at least one subscriber on a display of the client device associated with the at least one other subscriber and wherein modifying the activity comprises modifying the activity of the at least one other subscriber based on the activity indictor.

14. The method of claim 13, wherein the activity of the at least one subscriber comprises a current activity, a past activity and/or a future activity, wherein the activity indicator further illustrates a mood of the at least one subscriber, the mood indicating the at least one subscriber's satisfaction with the current activity, the past activity and/or the future activity.

15. The method of claim 12, wherein modifying comprises automatically modifying the activity of the at least one other subscriber of the presence service to be the same as the activity of the at least one subscriber.

16. The method of claim 12, wherein modifying is preceded by receiving an invitation to join a current activity and/or a future of the at least one subscriber.

17. A computer program product for managing user information across multiple devices associated with the user, the computer program product comprising computer program code embodied in a computer readable medium, the computer program code comprising program code configured to carry out the method of claim 12.

18. A computer system configured to carry out the method of claim 12.

19. A computer program product for providing activity data, the computer program product comprising:
computer readable storage medium having computer readable program code embodied in said medium, the computer readable program code comprising:
computer readable program code configured to provide, to a presence server, activity data associated with an activity of at least one subscriber of a presence service, the presence server being configured to provide the activity data to at least one other subscriber of the presence service by altering an activity indicator associated with the activity of the at least one subscriber on a display of a client device associated with the at least one other subscriber; and
computer readable program code configured to modify an activity of the at least one other subscriber of the presence service based on the activity indicator associated with the activity of the at least one subscriber.

20. A computer system configured to carry out the computer program product of claim 19.
